(19) United States
(12) Patent Application Publication
(10) Pub. No.: US 2018/0183095 A1
(43) Pub. Date: Jun. 28, 2018

(54) ALL SOLID BATTERY WITH IMPROVED ENERGY DENSITY AND METHOD OF MANUFACTURING THE SAME

(71) Applicants: Hyundai Motor Company, Seoul (KR); Kia Motors Corporation, Seoul (KR); Ulsan National Institute of Science and Technology, Ulsan (KR)

(72) Inventors: Oh Min Kwon, Busan (KR); Yong Sub Yoon, Seoul (KR); Hong Seok Min, Gyeonggi-do (KR); Pil Gun Oh, Daejeon (KR); Yoon Seok Jung, Ulsan (KR); Young Jin Nam, Gyeonggi-do (KR); Sung Hoo Jung, Gyeongsangnam-do (KR); Dae Yang Oh, Gyeonggi-do (KR)

(21) Appl. No.: 15/822,809

(22) Filed: Nov. 27, 2017

(30) Foreign Application Priority Data
Dec. 28, 2016 (KR) 10-2016-0181655

(51) Int. Cl. H01M 10/0562; H01M 10/0525; H01M 4/62; H01M 10/058; H01M 4/04

(52) U.S. Cl. CPC H01M 10/0562; H01M 10/0525; H01M 4/62; H01M 2300/008; H01M 4/0404; H01M 4/0428; H01M 2220/20; H01M 10/058

(57) ABSTRACT

Disclosed are an all solid battery including a positive electrode layer including a positive electrode active material, a solid electrolyte and a conductive material coated with an insulator coating layer, an electrolyte layer, and a negative electrode layer and a method of manufacturing an all solid battery the same. In particular, the method includes: coating, by atomic layer deposition (ALD), a conductive material with an insulator by atomic layer deposition (ALD) to produce a conductive material surrounded by an insulator coating layer; producing a positive electrode layer including the conductive material coated with the insulator coating layer-formed conductive material, a positive electrode active material, and a solid electrolyte; and stacking and pressing the positive electrode layer produced above, an electrolyte layer and a negative electrode layer. The all solid battery can suppress side-reactions between the conductive material and the solid electrolyte, thereby advantageously maximizing energy density based on improved initial charge/discharge efficiency, and enhancing lifespan and power.

### CROSS-REFERENCE TO RELATED APPLICATION

This application claims under 35 U.S.C. § 119(a) the benefit of priority to Korean Patent Application No. 10-2016-0181655 filed on Dec. 28, 2016, the entire contents of which are incorporated herein by reference.

### BACKGROUND

### (a) Technical Field

The present invention relates to an all solid battery with improved energy density and a method of manufacturing the same. The all solid battery can maximize energy density based on improved initial charge/discharge efficiency and exhibit enhanced lifespan and power.

### (b) Background Art

An all solid battery, which may be a lithium secondary battery using a solid electrolyte, is a potential next generation secondary battery expected to satisfy both stability and energy density. Such an all solid battery has a structure in which an electrolyte layer including a solid electrolyte and a positive electrode/negative electrode composite including a solid electrolyte are formed on both surfaces thereof and a current collector is bound to each electrode.

The all solid battery may not have particular advantages in terms of energy density of a single cell, as compared to a lithium ion battery conventionally commercially available as a battery system. However, the all solid battery may exert high energy density because of stability of the solid by adopting high-voltage high-capacity electrodes conventionally inapplicable to lithium ion battery systems. Using a high-voltage positive electrode active material such as LNMO spinel (5V class) having an operation voltage of about 5V may be one potent approach.

Meanwhile, techniques to suppress the problem of electrochemical side-reaction between a positive electrode active material and a solid electrolyte (e.g., increased interfacial resistance resulting from Li depletion) in conventional sulfide all solid battery systems have been developed.

Meanwhile, conventional sulfide all solid battery systems have other problems of side-reactions such as solid electrolyte decomposition and deterioration behaviors due to electrical conductivity of conductive materials used in the positive electrode layer. However, in the related arts, there has been no technical development developed to suppress solid electrolyte decomposition and deterioration behaviors caused by electrical conductivity of conductive materials.

Accordingly, there is a need for research on an all solid battery that is capable of suppressing side-reactions, such as deterioration behaviors, between a conductive material and a solid electrolyte upon application to high-voltage positive electrodes.

The above information disclosed in this Background section is only for enhancement of understanding of the background of the invention and therefore it may contain information that does not form the prior art that is already known in this country to a person of ordinary skill in the art.

### SUMMARY OF THE INVENTION

In preferred aspects, the present invention provides an all solid battery which may suppress side-reactions between a conductive material and a solid electrolyte, maximize energy density based on improved initial charge/discharge efficiency and enhance lifespan and power, and a method of manufacturing the same.

The term “all solid battery”, as used herein, refers to a battery including solid or solid-type components, particularly, solid electrodes and solid electrolytes.

In one aspect, the present invention may provide an all solid battery including a positive electrode layer including a positive electrode active material, a solid electrolyte and a conductive material. In particular, the conductive material may be coated with an insulator coating layer, an electrolyte layer, and a negative electrode layer.

The insulator coating layer may suitably include one selected from the group consisting of Al₂O₃, ZrO₂ and TiO₂. Preferably, the insulator coating layer may include Al₂O₃.

The insulator coating layer may suitably have a thickness of about 0.1 to 100 nm, and preferably may have a thickness of about 0.2 to 0.5 nm.

The insulator coating layer may suitably be present in an amount of 0.001 to 30% by weight with respect to the total weight of the conductive material coated with the insulator coating layer. In addition, the insulator coating layer may be present in an amount of 0.01 to 30%, in an amount of 0.01 to 10%, or preferably, in an amount of 0.1 to 10%, by weight with respect to the total weight of the conductive material coated with the insulator coating layer.

The solid electrolyte may be Li₆PS₄Cl.

In another aspect, the present invention provides a method of manufacturing an all solid battery. The method may include coating a conductive material with an insulator coating layer by atomic layer deposition (ALD), producing a positive electrode layer including the conductive material coated with insulator coating layer, a positive electrode active material, and a solid electrolyte, and stacking and pressing the positive electrode layer, an electrolyte layer and a negative electrode layer.

The insulator coating layer may suitably include one selected from the group consisting of Al₂O₃, ZrO₂, and TiO₂. Preferably, the insulator coating layer may include Al₂O₃.

The insulator coating layer may suitably have a thickness of about 0.1 to 100 nm. Preferably, the insulator coating layer may have a thickness of about 0.2 to 0.5 nm.

The insulator coating layer may suitably be present in an amount of about 0.001 to 30% by weight with respect to the total weight of the conductive material coated with the insulator coating layer.

The solid electrolyte may suitably be Li₆PS₄Cl.

Further provided is a vehicle that may comprise the all solid battery as described herein. Other aspects of the present invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 shows an exemplary process of a first coating with Al₂O₃ to form an exemplary insulator coating layer by atomic layer deposition (ALD);

FIG. 2 shows electrochemical analysis results of exemplary all solid batteries produced in Examples 1 and 2 according to exemplary embodiments of the present invention, and Comparative Examples 1 and 2;

FIG. 3 shows electrochemical analysis results of exemplary all solid batteries produced in Example 2 according to an exemplary embodiment of the present invention, and Comparative Example 3; and

FIG. 4 is a graph comparing lifespan characteristics between an exemplary all solid batteries produced in Example 2 and Comparative Example 1.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawings.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, reference will be made in detail to various embodiments of the present invention, examples of which are illustrated in the accompanying drawings and described below. While the invention will be described in conjunction with exemplary embodiments, it will be understood that the present description is not intended to limit the invention to the exemplary embodiments. On the contrary, the invention is intended to cover not only the exemplary embodiments, but also various alternatives, modifications, equivalents and other embodiments, which may be included within the spirit and scope of the invention as defined by the appended claims. In the following description of the present invention, detailed descriptions of known functions and configurations incorporated herein will be omitted when it may obscure the subject matter of the present invention.

The present invention provides an all solid battery including a positive electrode layer, an electrolyte layer, and a negative electrode layer. In particular, the positive electrode layer may include a positive electrode active material, a solid electrolyte and a conductive material coated with an insulator coating layer.

In another aspect, the present invention provides a method of manufacturing an all solid battery and the method may include: i) coating a conductive material with an insulator coating layer by atomic layer deposition (ALD); ii) producing a positive electrode layer including the conductive material coated with the insulator coating layer, a positive electrode active material and a solid electrolyte, and iii) stacking and pressing the produced positive electrode layer , an electrolyte layer and a negative electrode layer.

Conventional methods may have problems of side-reactions such as solid electrolyte decomposition and deterioration behaviors due to electrical conductivity of conductive materials used in the positive electrode layer.

Accordingly, the present inventors have designed a method of suppressing side reactions by coating conductive materials with an insulator. For example, due to electrical conductivity of conductive materials, side-reactions of deterioration behaviors between a conductive material and a solid electrolyte may occur upon applying high-voltage positive electrodes.

Hereinafter, an all solid battery and a method of manufacturing the same according to various exemplary embodiments of the present invention will be described in more detail.

In one aspect, the present invention provides an all solid battery including a positive electrode layer, an electrolyte layer, and a negative electrode layer. The positive electrode layer may include a positive electrode active material, a solid electrolyte and a conductive material coated with an insulator coating layer.

In the all solid battery, the conductive material used in the positive electrode layer may have electrical conductivity. The electrical conductivity of the conductive material may result in problems of side-reactions such as decomposition and deterioration behaviors of the solid electrolyte. On the other hand, an exemplary conductive material of an exemplary all solid battery according to an exemplary embodiment of the present invention may suppress side-reactions such as deterioration behaviors between the conductive material and the solid electrolyte because the conductive material may be suitably coated with an insulator coating layer.

The insulator coating layer may suitably include one selected from the group consisting of Al₂O₃, ZrO₂ and TiO₂, and may be preferably Al₂O₃.

Meanwhile, the insulator coated on the conductive material may form a coating layer on the surface of the conductive material and the thickness of the insulator coating layer may vary depending on size, shape and surface area of conductive material particles.

In an embodiment, the thickness of the insulator coating layer may suitably be from about 0.1 to about 100 nm. When the thickness of the insulator coating layer is less than about 0.1 nm, side-reaction may not be sufficiently suppressed and, when the thickness is greater than about 100 nm, electrical conductivity of the electrode may be effected or reduced, thus causing deterioration in performance such as capacity and power density.

In addition, the thickness of the insulator coating layer may range from about 0.2 to about 0.5 nm.

Meanwhile, the insulator coating layer may be present in an amount of about 0.001 to 30% by weight with respect to the total weight of the conductive material coated with the insulator coating layer. When the content of the insulator coating layer is less than about 0.001% by weight of the total weight of the conductive material coated with the insulator coating layer, side-reaction may not be sufficiently suppressed due to insufficient thickness of the coating layer, and when the content is greater than about 30% by weight, electrical conductivity may be effected or reduced, thus causing deterioration in performance.

Meanwhile, coating the conductive material may be carried out by any method in the related arts, such as wet coating and/or atomic layer deposition (ALD).

In addition, any solid electrolyte may not be particularly limited, and be a sulfide-based solid electrolyte used in the related arts and the solid electrolyte may be preferably Li₆PS₄Cl.

In particular, an LNMO positive electrode active material, which is a high-voltage positive electrode material among positive electrode active materials, may further need to suppress side-reactions of conductive materials by coating the conductive material with the insulating material or an insulator coating layer, because it has a voltage range which cannot guarantee electrochemical stability of the sulfide-based solid electrolyte.

In another aspect, the present invention provides a method of manufacturing an all solid battery. The method may include: i) coating a conductive material with an insulator coating layer by atomic layer deposition (ALD); ii) producing a positive electrode layer including the conductive material coated with the insulator coating layer, a positive electrode active material and a solid electrolyte, and iii) stacking and pressing the produced positive electrode layer , an electrolyte layer and a negative electrode layer.

The coating the conductive material with the insulator may be preferably carried out by ALD.

Atomic layer deposition (ALD) is a method of growing a thin film by forming one atomic layer at a time by depositing individual elements included in the thin film in a sequential manner. In such an ALD technique, a reactant may react only with a wafer surface and reactions between reactants may not occur due to self-limiting reaction, which is distinguished from CVD. Accordingly, according to reaction mechanism of the surface, a single layer may be deposited repeatedly to control the thickness of the thin film. In addition, ALD may easily control the thickness of the thin film and exert excellent uniformity and characteristics of thin films, as compared to CVD. Furthermore, ALD may provide superior coating properties because a thin film with a predetermined thickness may be suitably formed, regardless of irregularities of surfaces of substrates.

Typically, in contrast to general wet coating, ALD may provide advantages of forming considerably uniform coating layers to offer accurate comparison and analysis, controlling the thickness of the coating layer at the angstrom (Å) level, allowing for deposition on wide substrates, being applicable to complicated three-dimensional substrates and generally having low-temperature deposition conditions.

In addition, in the production of the conductive material coated with the insulator coating layer, the insulator material such as Al₂O₃ having insulation properties may be used. For this reason, the insulating material may lose its function as an electron transfer channel in the electrode and thus may cause deterioration in power density, when the coating layer gets thickened. Accordingly, coating by ALD may prevent this deterioration, and the electron transfer channel may be further secured. In consideration of this, the present invention preferably adopts ALD as a coating method.

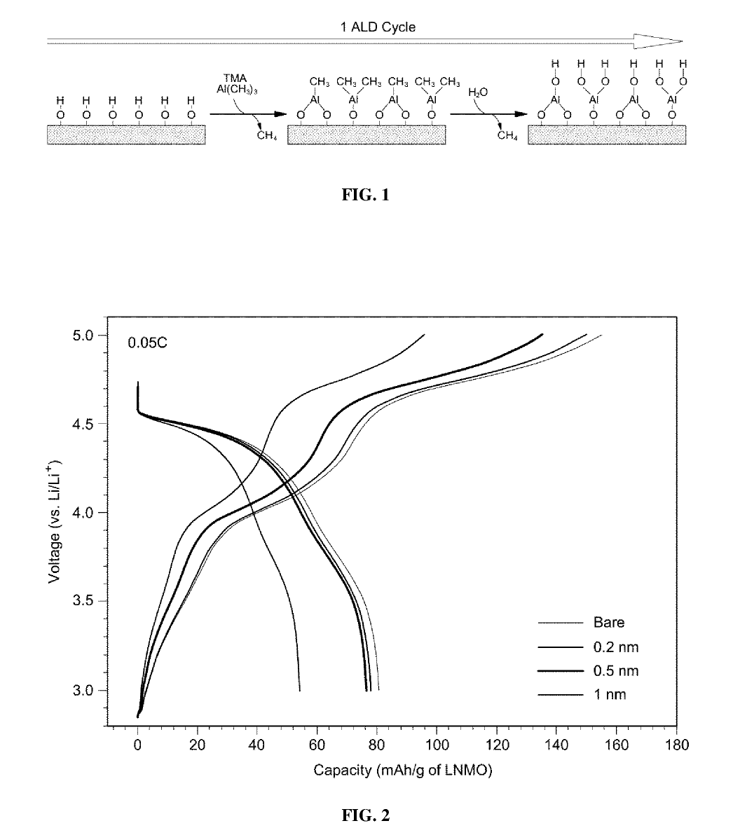

FIG. 1 shows an exemplary step of a first coating cycle during coating with Al₂O₃ by ALD. For instance, a conductive material may be charged in an ALD chamber and heated to a process temperature, and vacuum may be established. After the process temperature is achieved, a predetermined amount of precursor-1 (TMA) may be fed to sufficiently induce surface reaction of the substance. Then, vacuum may be established again to remove unreacted precursor-1 (TMA) from the chamber, and a precursor-2 (H2O) may be fed into the chamber to induce reaction to form an Al₂O₃ coating layer. A reaction including feeding TMA and H2O into the chamber may be defined by one cycle and ALD cycles may be conducted repeatedly depending on the desired thickness to produce a sample.

### EXAMPLE

Hereinafter, the present invention will be described in more detail with reference to preferred examples. However, these examples are provided only for illustration of the present invention and should not be construed as limiting the scope of the present invention.

### Example 1

As a conductive material SUPERC65 (produced by TIMCAL LTD.) was charged to an ALD chamber and then a temperature was increased to 150° C. such that vacuum was established. After a process temperature reached about 150° C., a predetermined amount of precursor-1 (TMA) was fed to sufficiently induce surface reaction of SUPERC65. Then, vacuum was established again to remove unreacted precursor-1 (TMA) from the chamber, and a precursor-2 (H₂O) was fed into the chamber to induce reaction to form an Al₂O₃ coating material. ALD cycles (a reaction including feeding TMA and H₂O into the chamber is defined by one cycle) were conducted until the Al₂O₃ coating layer was formed to a thickness of 0.2 nm to produce a conductive material including the Al₂O₃ coating layer.

The conductive material including an Al₂O₃ coating layer, LNMO as a positive electrode active material and Li₆PS₄Cl as a sulfide-based solid electrolyte were mixed in a weight ratio (positive electrode active material: solid electrolyte: conductive material=30:70:6) to produce a positive electrode layer, an electrolyte layer was produced using a sulfide-based solid electrolyte, and a negative electrode layer was produced using a reference electrode Li0.5In powder. The respective layers were pelletized by pressing to produce an all solid secondary battery.

### Example 2

An all solid secondary battery was produced in the same manner as in Example 1, except that ALD cycles were conducted until the thickness of the Al₂O₃ coating layer reached 0.5 nm to produce a conductive material including the Al₂O₃ coating layer.

### Comparative Example 1

SUPERC65 (produced by TIMCAL LTD.) as a conductive material, LNMO as a positive electrode active material and Li₆PS₄Cl as a sulfide-based solid electrolyte were mixed in a weight ratio (positive electrode active material: solid electrolyte : conductive material=30:70:6) to produce a positive electrode layer, an electrolyte layer was produced using a sulfide-based solid electrolyte, and a negative electrode layer was produced using a reference electrode Li0.5In powder. The respective layers were pelletized by pressing to produce an all solid secondary battery.

### Comparative Example 2

An all solid secondary battery was produced in the same manner as in Example 1, except that ALD cycles were conducted until the thickness of the Al₂O₃ coating layer reached 1 nm to produce a conductive material including the Al₂O₃ coating layer.

### Comparative Example 3

An all solid secondary battery was produced in the same manner as in Example 2, except that a conductive material including the Al₂O₃ coating layer was produced by wet coating.

### Test Example 1

The all solid batteries produced in Examples 1 and 2, and Comparative Examples 1 and 2 were operated at a temperature of 30° C. at a constant C-rate of 0.05C based on 1C=140 mA/g within the limited range from 3.0V to 5.0V and electrochemical analysis results were obtained and are shown in the following Table 1. In addition, FIG. 2 is a graph showing electrochemical analysis results of exemplary all solid batteries produced in Examples 1 and 2 according to exemplary embodiments of the present invention, and Comparative Examples 1 and 2.

TABLE 1

| | Capacity | Capacity | ICE |
|---|---|---|---|
| | (mAh/g, ch) | (mAh/g, dis) | (%) |
| Comparative | 154.91 | 80.70 | 52.09 |
| Example 1 | | | |
| Example 1 | 149.63 | 78.95 | 52.76 |
| Example 2 | 135.03 | 76.57 | 56.71 |
| Comparative | 95.64 | 56.24 | 58.80 |
| Example 2 | | | |

### Test Example 2

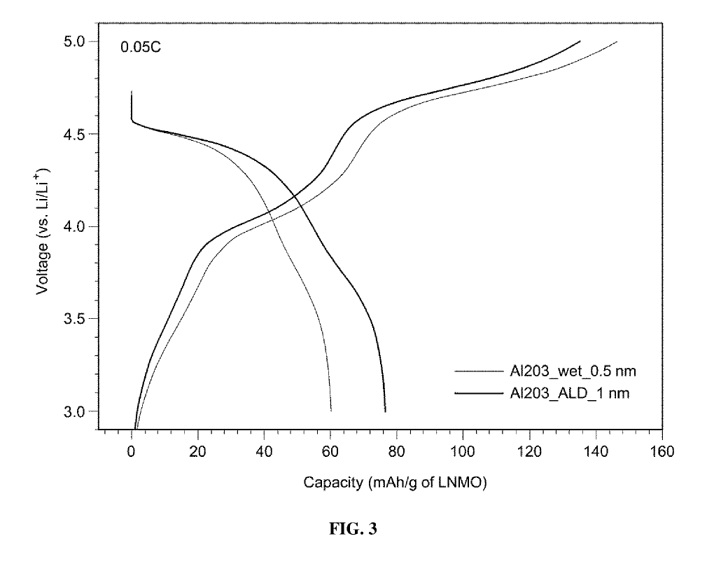

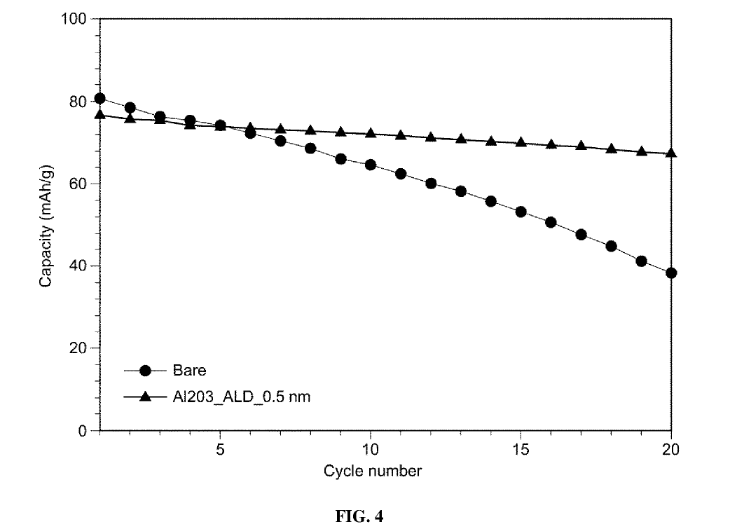

The all solid batteries produced in Example 2, and Comparative Example 3 were operated at a temperature of 30° C. at a constant C-rate of 0.05C based on 1C=140 mA/g within the limited range from 3.0V to 5.0V and electrochemical analysis results were obtained and are shown in the following Table 2. In addition, FIG. 3 is a graph showing electrochemical analysis results of exemplary all solid batteries produced in Example 2 according to an exemplary embodiment of the present invention and Comparative Example 3.

TABLE 2

| | Capacity | Capacity | ICE |
|---|---|---|---|
| | (mAh/g, ch) | (mAh/g, dis) | (%) |
| Comparative | 146.30 | 60.17 | 41.13 |
| Example 3 | | | |
| Example 2 | 135.03 | 76.57 | 56.71 |

### Test Example 3

Lifespan characteristics were compared between exemplary all solid batteries produced in Example 2 and Comparative Example 1 and results are shown in FIG. 4.

As can be seen from the results of Test Examples, the all solid batteries according to various exemplary embodiments of the present invention may suppress side-reactions between the conductive material and the solid electrolyte, thereby maximizing energy density based on improved initial charge/discharge efficiency, and enhancing lifespan and power.

In addition, the all solid battery according to various exemplary embodiments of the present invention may suppress side-reactions between the conductive material and the solid electrolyte, thereby advantageously maximizing energy density based on improved initial charge/discharge efficiency, and enhancing lifespan and power.

The invention has been described in detail with reference to various exemplary embodiments thereof. However, it will be appreciated by those skilled in the art that changes may be made in these embodiments without departing from the principles and spirit of the invention, the scope of which is defined in the appended claims and their equivalents.

What is claimed is:

1. An all solid battery comprising:
a positive electrode layer comprising a positive electrode active material, a solid electrolyte and a conductive material coated with an insulator coating layer;
an electrolyte layer; and
a negative electrode layer.

2. The all solid battery according to claim 1, wherein the insulator coating layer comprises Al₂O₃, ZrO₂ and/or TiO₂.

3. The all solid battery according to claim 2, wherein the insulator coating layer comprises Al₂O₃.

4. The all solid battery according to claim 1, wherein the insulator coating layer has a thickness of about 0.1 to 100 nm.

5. The all solid battery according to claim 4, wherein the insulator coating layer has a thickness of about 0.2 to 0.5 nm.

6. The all solid battery according to claim 1, wherein the insulator coating layer is present in an amount of 0.001 to 30% by weight with respect to the total weight of the conductive material coated with the insulator coating layer.

7. The all solid battery according to claim 1, wherein the solid electrolyte is Li₆PS₄Cl.

8. A method of manufacturing an all solid battery comprising:
coating a conductive material with an insulator coating layer by atomic layer deposition (ALD);
producing a positive electrode layer the conductive material coated with the insulator coating layer, a positive electrode active material, and a solid electrolyte; and
stacking and pressing the positive electrode layer, an electrolyte layer and a negative electrode layer.

9. The method according to claim 8, wherein the insulator coating layer comprises Al₂O₃, ZrO₂ and/or TiO₂.

10. The method according to claim 9, wherein the insulator coating layer comprises Al₂O₃.

11. The method according to claim 8, wherein the insulator coating layer has a thickness of about 0.1 to 100 nm.

12. The method according to claim 11, wherein the insulator coating layer has a thickness of about 0.2 to 0.5 nm.

13. The method according to claim 8, wherein the insulator coating layer is present in an amount of 0.001 to 30% by weight with respect to the total weight of the conductive material coated with the insulator coating layer.

14. The method according to claim 8, wherein, the solid electrolyte is Li₆PS₄Cl.

15. A vehicle comprising an all solid battery of claim 1.
